(19) United States
(12) Patent Application Publication
(10) Pub. No.: US 2011/0078609 A1
(43) Pub. Date: Mar. 31, 2011

(54) SERVICE USING DEVICE

(75) Inventor: Kazuyuki Shibuya, Sagamihara-shi (JP)

(73) Assignee: OLYMPUS CORPORATION, Tokyo (JP)

(21) Appl. No.: 12/891,017

(22) Filed: Sep. 27, 2010

(30) Foreign Application Priority Data
Sep. 28, 2009 (JP) 2009-222447

(51) Int. Cl. G06F 3/048; G06F 15/16

(52) U.S. Cl. 715/771; 709/206

(57) ABSTRACT

A service using device operates as a UPnP control point using a service provided by a UPnP device. The service using device includes a service registration unit, a storage unit, a trigger reception unit, a message transmission unit, and a processing unit. The service registration unit registers the service. The storage unit stores information indicating whether the registered service is in use. The trigger reception unit receives a switching trigger related to switching of the service use. The message transmission unit transmits an acknowledgement message for checking whether a service stored as a service not in use is valid to a network when the trigger reception unit receives the switching trigger. The processing unit performs processing based on a response to the acknowledgement message.

### BACKGROUND OF THE INVENTION

1. Field of the Invention

The present invention relates to a service using device which operates as a UPnP control point to use a service provided by a UPnP device.

Priority is claimed on Japanese Patent Application No. 2009-222447, filed Sep. 28, 2009, the content of which is incorporated herein by reference.

2. Description of Related Art

Recently, the number of devices (service providing devices) which provide services to other devices or the number of devices (service using devices) which control and use the provided services has increased as in the case where a video stored in a PC, a NAS, or the like is received and watched on a TV via a LAN in a small-scale LAN such as in a home. In terms of service provision and service use within the LAN, UPnP is mainly used as a technique for establishing a mutual connection between devices. For example, it is possible to refer to UPnP from UPnP Device Architecture 1.0. [online]. UPnP Forum, 2008 Oct. 15. [retrieved on 2009 Sep. 15]. Retrieved from the Internet: <URL:http://www.upnp.org/specs/arch/UPnP-arch-DeviceArchitecture-v1.0.pdf>.

A service using device may display available service providing devices found on a user interface (hereinafter, referred to as UI) according to UPnP using icons or the like. In general, an icon may be deleted from the UI by the service using device receiving a network leave message (ssdp: byebye) transmitted when a UPnP operation is ended by a service provided by the service providing device (for example, at power-off or network disconnection time).

For example, a service provided by the service providing device may not transmit the network leave message when the service is unintentionally withdrawn from a network, as in the case where a LAN cable is unplugged during a UPnP operation, the service providing device leaves a wireless area, or battery or AC power supply is unplugged from the service providing device. In this case, the service using device does not directly detect the withdrawal of service. Consequently, when a user of the service using device wants to use a service not currently in use, an unintentionally withdrawn service may also be selected. As described above, there is a problem in that the service using device may not accurately recognize available services.

In the general UPnP operation, the presence of a service is reconfirmed by the service using device receiving a network join notification (ssdp: alive) periodically transmitted from the service, but, according to the UPnP specification, it is recommended that the transmission interval of network join notifications be 1800 sec or more. In other words, some service using devices may determine that the service is withdrawn from a network when 1800 sec or more has elapsed after these service using devices receive the previous network join notification. Thus, in some services based on UPnP, the transmission interval of the network join notification is usually set as a slightly shorter time (for example, 1700 sec) than the recommended period of 1800 sec in order to keep network connectivity. That is, an unintentionally withdrawn service is selectable for at most 1800 sec on the service using device.

In Japanese Unexamined Patent Application Publication No. 2007-110733, the following structure is provided so that the service using device may rapidly detect the unintended withdrawal of service and may more accurately recognize available services. When a plurality of service using devices uses services, the service using devices perform adjustment with services, and one service using device is responsible for the role of a monitoring device which monitors the withdrawal of service. The monitoring device periodically transmits an event registration update (Subscribe (Renew) message) to the service at an interval when UPnP event registration (Subscribe message) has not timed out, and detects the unintended withdrawal of service by the availability of responses thereto. If an unintended withdrawal of service is detected, the monitoring device performs a multicast transmission of a network leave message within the network. Since the event registration update is transmitted from the service using device, the event registration update is transmitted at a shorter interval than that of a network join notification transmitted from the service. Thereby, the monitoring device is able to rapidly detect an unexpected withdrawal of service.

### SUMMARY OF THE INVENTION

In one aspect of the present invention, there is provided a service using device which operates as a UPnP control point using a service provided by a UPnP device, comprising: a service registration unit which registers the service; a storage unit which stores information indicating whether the registered service is in use; a trigger reception unit which receives a switching trigger related to switching of the service use; a message transmission unit which transmits an acknowledgement message for checking whether a service stored as a service not in use is valid to a network when the trigger reception unit receives the switching trigger; and a processing unit which performs processing based on a response to the acknowledgement message.

Preferably, the service using device may further comprise a display unit which displays a registered service, and the trigger reception unit may receive the switching trigger when the display unit performs switching from a state in which other information excluding information for selecting the service is displayed to a state in which the information for selecting the service is displayed.

Preferably, the trigger reception unit may receive the switching trigger when a service use end process is performed for a service in use. Preferably, the service using device may further comprise a message reception unit which receives a network leave message from the UPnP device, the trigger reception unit may receive a reception trigger when the message reception unit receives the network leave message, and the message transmission unit may transmit the acknowledgement message to the network when the trigger reception unit receives the reception trigger.

Preferably, the service using device may further comprise an operation unit which receives an operation input by a user to the service using device, and the trigger reception unit may receive the switching trigger when the operation input is received.

Preferably, the service using device may further comprise a display unit which displays a valid service, and the processing unit may cause the display unit to display the valid service to be distinguishable from an invalid service.

Preferably, the storage unit may store information regarding a scheduled service to be used next to a service in current use, and the processing unit may decide whether to use the scheduled service based on a response to the acknowledgement message.

### BRIEF DESCRIPTION OF THE DRAWINGS

The above features and advantages of the present invention will be more apparent from the following detailed description of certain preferred embodiments taken in conjunction with the accompanying drawings, in which:

FIG. 1 is a block diagram showing the configurations of a digital still camera and an optical disk recorder according to an embodiment;

FIG. 2 is a rear view of the digital still camera according to an embodiment;

FIG. 3 is a functional configuration diagram showing UPnP functions provided in the digital still camera and the optical disk recorder according to an embodiment;

FIG. 4 is a flowchart showing a procedure of the operation of the digital still camera according to an embodiment;

FIG. 5 is a flowchart showing a procedure of the operation of the digital still camera according to an embodiment;

FIG. 6 is a flowchart showing a procedure of the optical disc recorder according to an embodiment;

FIG. 7 is a sequence diagram showing a communication procedure to be performed between the digital still camera and the optical disc recorder according to an embodiment;

FIG. 8 is a sequence diagram showing a communication procedure to be performed between the digital still camera and the optical disc recorder according to an embodiment; and

FIG. 9 is a rear view of the digital still camera according to an embodiment.

### DETAILED DESCRIPTION OF THE PREFERRED EMBODIMENTS

The present invention will be now described herein with reference to illustrative embodiments. Those skilled in the art will recognize that many alternative embodiments can be accomplished using the teachings of the present invention and that the invention is not limited to the embodiments illustrated for explanatory purposes.

The embodiments of the present invention will now be described with reference to the drawings. This embodiment will be described using a digital still camera as an example of a service using device having a function of a UPnP control point. The present invention is not limited thereto, and a device having a function of the UPnP control point connectable to a network such as a PC, a mobile phone, a PDA, an optical disc/HDD recorder, a TV, a gaming machine, or a video camera is available as the service using device.

On the other hand, this embodiment will be described using an optical disc recorder having a UPnP device, which provides content server related services, as an example of a service providing device which provides a service. The present invention is not limited thereto, and UPnP device equipment having the UPnP device connectable to a network such as a PC, a NAS, a mobile phone, or a digital still camera is available as the service providing device.

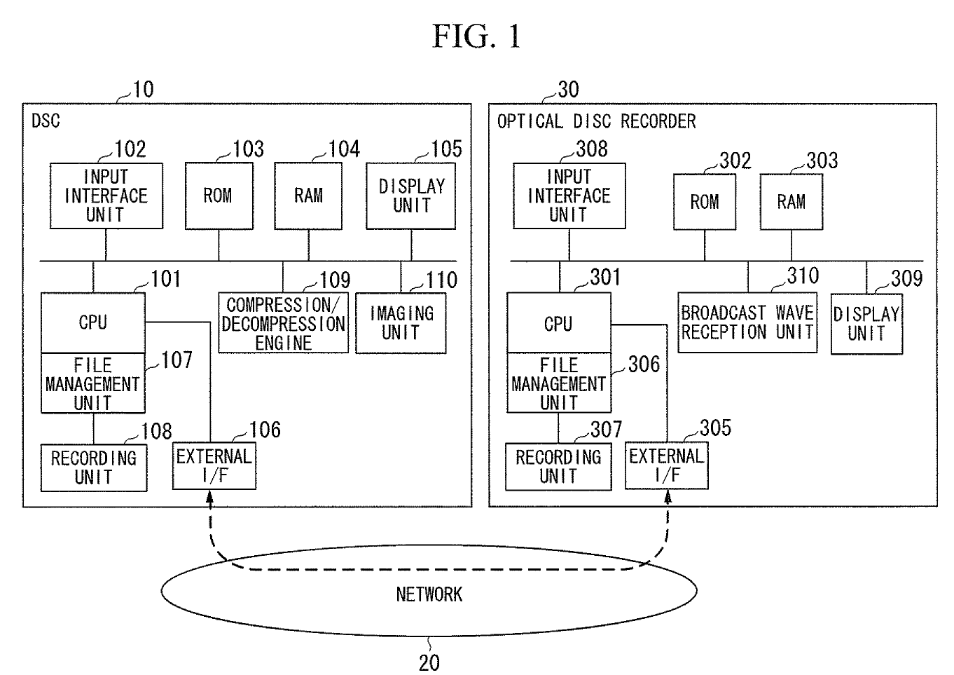

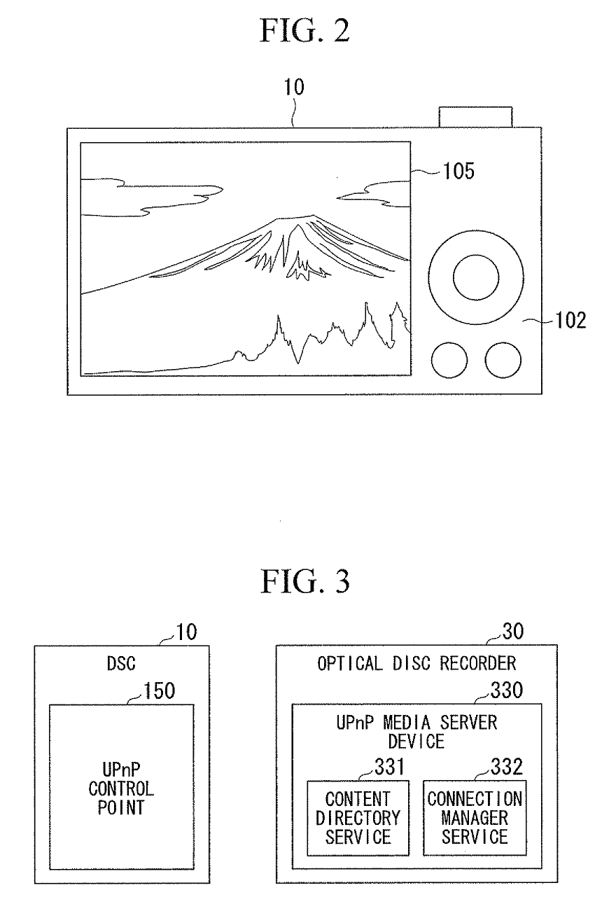

FIG. 1 shows the configuration of a digital still camera (hereinafter, abbreviated as DSC) and an optical disc recorder according to an embodiment of the present invention. A DSC 10 operates as a control device having a function of a UPnP control point. An optical disc recorder 30 is connected to the DSC 10 via a network 20, and operates as a service providing device having a UPnP device. FIG. 2 shows the backside of the DSC 10.

As shown in FIG. 1, the DSC 10 has a CPU 101, an input interface unit 102, a

ROM 103, a RAM 104, a display unit 105, an external I/F (external interface) 106, a file management unit 107, a recording unit 108, a compression/decompression engine 109, and an imaging unit 110.

By using the RAM 104 in a work area, the CPU 101 performs various controls according to a control program stored in the ROM 103. The CPU 101 is connected to the network 20 via the external I/F 106 by a wired or wireless network protocol, and is communicable with the external optical disc recorder 30. Data to be transmitted and received upon communication with the external optical disc recorder 30 is stored in the RAM 104.

The input interface unit 102 is an operation input unit such as a switch, a button, a key, a dial, and the like for allowing a user to perform an operation input to the DSC 10. Also, the input interface unit 102 may be a touch panel superposed on the display unit 105, or the like. The display unit 105 is able to display an image, an operation menu, or the like. The file management unit 107 manages a file recorded on the recording unit 108 according to an instruction from the CPU 101.

The recording unit 108 may be a non-volatile recording medium such as a semiconductor memory, a magnetic memory, a magnetic disc, an optical disc, or a magneto-optical disc, but is not limited thereto. The recording unit 108 may be a non-volatile recording medium capable of recording information and may be a combination of the above-described recording media. The recording unit 108 may include a plurality of recording media as well as a single recording medium.

The compression/decompression engine 109 compresses and decompresses an image. The imaging unit 110 captures an object image and generates imaging data.

In the DSC 10 of the above-described configuration, the CPU 101 takes in the imaging data from the imaging unit 110 according to an instruction input to the input interface unit 102 upon photographing. Also, as shown in FIG. 2, the CPU 101 displays an image based on the imaging data on the display unit 105, and stores the imaging data within the RAM 104. If the CPU 101 instructs the compression/decompression engine 109 to perform compression, the compression/decompression engine 109 compresses the imaging data within the RAM 104 into an image in a format designated by the CPU 101. The compressed image is recorded on the recording unit 108 through the file management unit 107 by an instruction from the CPU 101.

At the time of playing an image recorded on the recording unit 108, first, the image within the recording unit 108 is read out through the file management unit 107 by an instruction from the CPU 101, and the image is decompressed by the compression/decompression engine 109 according to a recorded format. The decompressed image is displayed on the display unit 105. In a state in which a setting screen for performing settings related to the DSC 10 and the image upon imaging and playing is displayed on the display unit 105, the user is able to perform settings of the DSC 10 by using the input interface 102.

On the other hand, the optical disc recorder 30 includes a CPU 301, a ROM 302, a RAM 303, an external I/F 305, a file management unit 306, a recording unit 307, an input interface unit 308, a display unit 309, and a broadcast wave reception unit 310.

According to a control program stored in the ROM 302, the CPU 301 performs various controls using the RAM 303 in a work area. Also, the CPU 301 is connected to the network 20 via the external I/F 305 by a wired or wireless network protocol, and is communicable with the external DSC 10. Data to be transmitted and received upon communication with the external DSC 10 is stored in the RAM 303.

The file management unit 306 manages a file recorded on the recording unit 307 according to an instruction from the CPU 301. The recording unit 307 is a recording medium, and will be described under the assumption that the recording unit 307 is an optical disc, but the same description as that of the recording unit 108 also applies to the recording unit 307.

The input interface unit 308 is an operation input unit for allowing the user to perform an operation input to the optical disc recorder 30, and the same description as that of the above-described input interface unit 102 is also applied to the input interface unit 308. The display unit 309 is able to display an operation menu, the state of the optical disc recorder 30, or the like.

When an image is transmitted to the external DSC 10 via the external I/F 305, an image within the recording unit 307 is first read out through the file management unit 306 by an instruction from the CPU 301, and is transmitted via the external I/F 305.

The broadcast wave reception unit 310 is a reception unit for receiving a transmitted broadcast wave, and reception content is recorded on the recording unit 307 through the file management unit 306 when necessary by a determination of the CPU 301.

Communication of the DSC 10 and the optical disc recorder 30 may be performed in infrastructure mode via a relay terminal such as an access point, or may be performed in ad-hoc mode of direct mutual communication without involving a relay terminal

Next, UPnP functions provided in the DSC 10 and the optical disc recorder 30 will be described. As shown in FIG. 3, the DSC 10 internally includes a UPnP control point 150 corresponding to a service registration unit, a trigger reception unit, a message transmission unit, a processing unit, and a message reception unit. A storage unit corresponds to the RAM 104, and an operation unit corresponds to the interface unit 102. The optical disc recorder 30 internally includes a UPnP media server device 330.

Respective functions of the UPnP control point 150 and the UPnP media server device 330 are implemented by a software process performed by the CPU 101 or the CPU 301 according to the control program.

Further, the UPnP media server device 330 has a content directory service 331 and a connection manager service 332. The content directory service 331 provides a service of managing content on a directory. The connection manager service 332 provides a service related to a connection for communicating content.

The UPnP control point 150 is able to play content recorded on the recording unit 307 of the optical disc recorder 30 on the DSC 10 by controlling the content directory service 331 and/or the connection manager service 332 for the UPnP media server device 330.

Next, the operation of the DSC 10 will be described. If a service to be used is assumed to be switched in this embodiment, the DSC 10 rapidly detects the withdrawal of service by transmitting a message for checking whether or not a service not in current use is valid and checking service validity. Thereby, the DSC 10 is able to accurately recognize an available service.

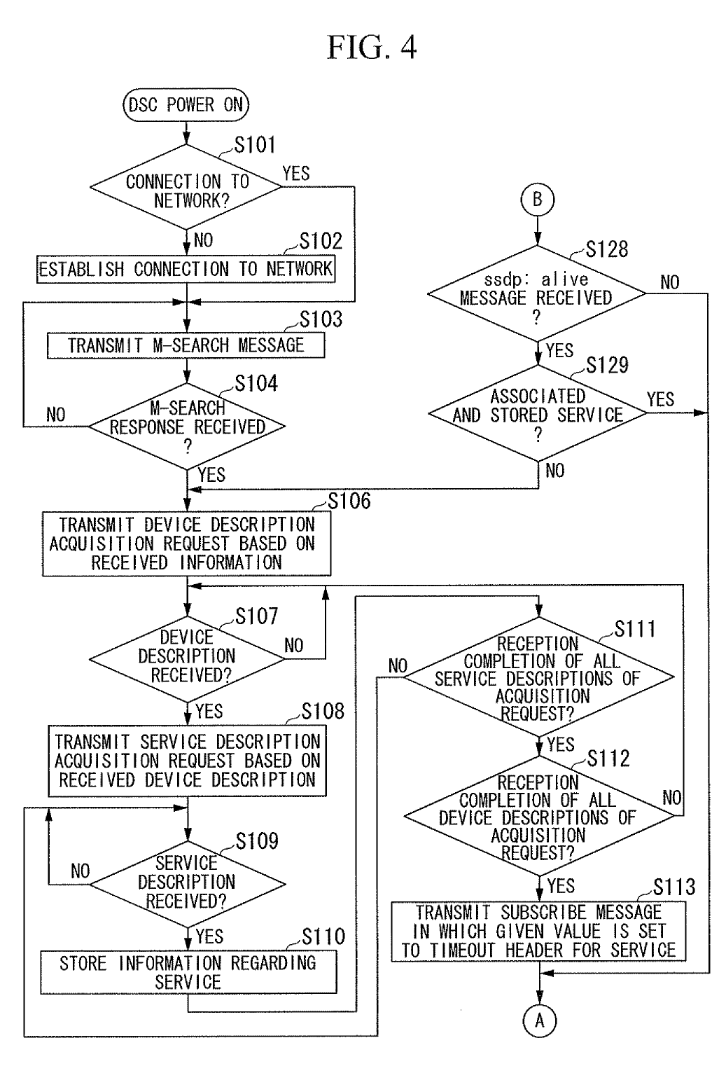

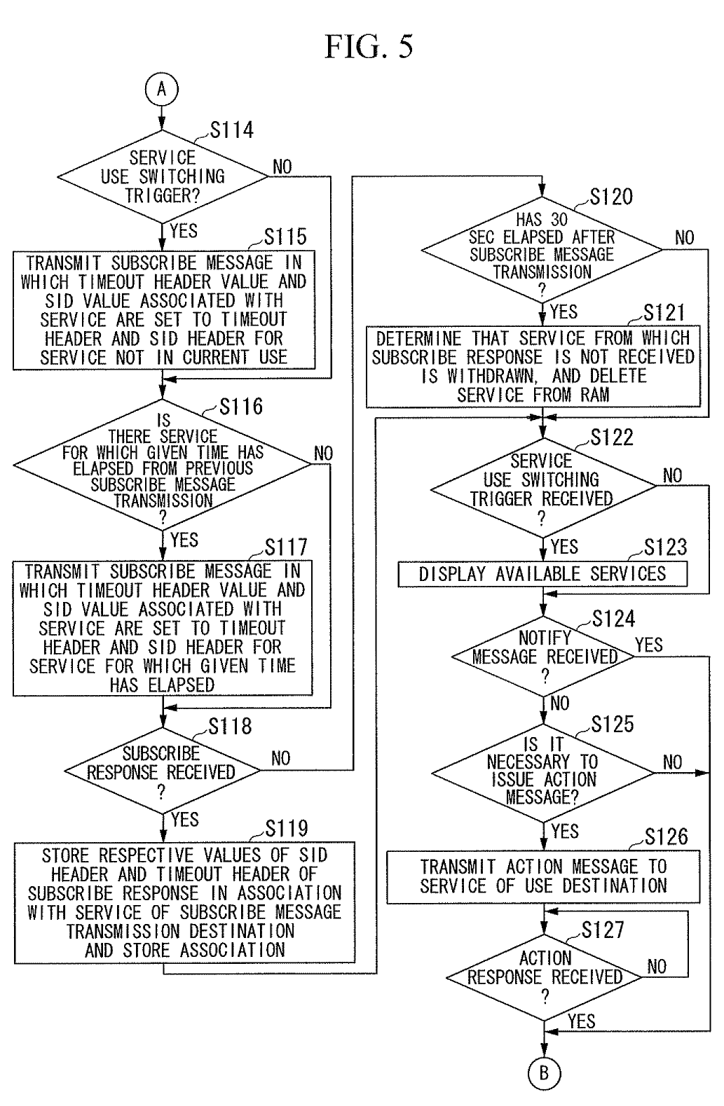

FIGS. 4 and 5 show a procedure of the operation of the DSC 10. Steps S103, S104, S106 to S113, and S124 to S127 are processing steps of the UPnP control point of the related art. When the DSC 10 is powered on, the UPnP control point 150 determines whether or not a connection to the network is established (step S101). If the connection to the network is not established, the UPnP control point 150 establishes a connection to the network (step S102). Thereafter, the process proceeds to step S103.

On the other hand, if the connection to the network is established, the UPnP control point 150 transmits an M-SEARCH message for finding a UPnP device on the network (step S103). Subsequently, the UPnP control point 150 determines whether or not a response to the M-SEARCH message is received (step S104). If the response to the M-SEARCH message is not received from any UPnP device and service within a fixed time, the process returns to step S103.

On the other hand, if the response to the M-SEARCH message is received or if a network join notification (ssdp: alive) is received from a service from which a Subscribe message to be described later is not transmitted, the UPnP control point 150 transmits a device description acquisition request (a device information request using HTTP GET) for acquiring a device description (device information) including UPnP device information (manufacturer information, basic information of a service provided on a UPnP device, or the like) from a UPnP device found by the response to the M-SEARCH message or the network join notification (step S106). Subsequently, the UPnP control point 150 determines whether or not the device description is received (step S107). If the device description is not received, the process returns to step S107, and the determination is made once again.

On the other hand, if the device description is received, the UPnP control point 150 transmits a service description acquisition request (a service information request using HTTP GET) for acquiring a service description (service information) including service information regarding specific control content of a service to be provided by the UPnP device (step S108). The service description acquisition request is transmitted for each service. Subsequently, the UPnP control point 150 determines whether or not the service description is received (step S109). If the service description is not received, the process returns to step S109 and determination is made once again.

On the other hand, if the service description is received, the UPnP control point 150 stores the service information included in the service description in the RAM 104 (step S110). Thereby, the service to be provided by the UPnP device is registered in the service using device. Subsequently, the UPnP control point 150 determines whether or not service descriptions are received from all services as transmission destinations of the service description acquisition request (step S111). If there is a service from which the service description is not received, the process returns to step S109 so as to wait for the service description to be received.

On the other hand, if the service descriptions are received from all the services, the UPnP control point 150 determines whether or not device descriptions are received from all UPnP devices as transmission destinations of the device description acquisition request (step S112). If there is a UPnP device from which the device description is not received, the process returns to step S107 so as to wait for the device description to be received.

After receipt of the device description, the UPnP control point 150 transmits a Subscribe (event registration) message for registration to each service so that an event notification by a state change in each service within the UPnP device is received. At this time, an SID (Subscription ID: event registration ID) is not included in the Subscribe message, and a given value is set in the TIMEOUT header of the Subscribe message (step S113).

Subsequently, the UPnP control point 150 determines whether or not a service use switching trigger as a trigger for switching the service use is received (step S114).

For example, the service use switching trigger is the switching of display content to the display of a service list on the display unit 105 from another display. Another display means an operation of displaying other information excluding information for service selection in a state in which the service is not selectable, and, for example, means an operation of displaying an image played when an image play service is used. In the service list display, information such as the service name for selecting the service is displayed in a state in which the service is selectable.

The service use switching trigger may be a use termination of a service in current use in the UPnP control point 150, and may be the receipt of an operation input from the user. For example, the UPnP control point 150 displays a service list on the display unit 105, and stores information, indicating that a service is in use when the user selects an arbitrary service from the service list by using the input interface unit 102, in the RAM 104. Alternatively, in a state in which communication with either service is continuously performed by an Action or Notify message, information indicating that the service is in use may be stored in the RAM 104.

When the service use switching trigger is received, the UPnP control point 150 transmits a Subscribe message as an event registration update for a service not in current use. At this time, the value of a TIMEOUT header stored in association with the service is set to the TIMEOUT header of the Subscribe message, and a value of an SID stored in association with the service is set to the SID header (step S115).

Subsequently, the UPnP control point 150 determines whether there is a service for which a given time has elapsed after the previous Subscribe message is transmitted (step S116). Here, the given time is set to a value smaller than the value of the TIMEOUT header stored in step S119 to be described later. If step S119 is not performed, the process proceeds to step S118 without performing the process of step S116.

If there is a service for which the given time has elapsed as a determination result, the Subscribe message is transmitted as the event registration update to the service. At this time, a value of the TIMEOUT header stored in association with the service is set to the TIMEOUT header of the Subscribe message, and an SID value stored in association with the service is set to the SID header (step S117). If there is no service for which the given time has elapsed as a determination result of step S116 and after the end of step S117, the process proceeds to step S118.

Thereafter, the UPnP control point 150 determines whether a Subscribe response as a response to the Subscribe message is received from the transmission destination of the Subscribe message transmitted in at least any one of steps S113, S115, and S117 (step S118). If the Subscribe response is received, the UPnP control point 150 stores the value of the SID header and the value of the TIMEOUT header written within the Subscribe response in the RAM 104 in association with the service (service identification information) of the transmission destination of the Subscribe message (step S119).

On the other hand, when 30 sec has elapsed from the transmission of the Subscribe message in a state in which the Subscribe response is not received (step S120), the UPnP control point 150 determines that a service as the transmission destination of the Subscribe message is withdrawn, deletes the service from the RAM 104, and deletes the SID header value and the TIMEOUT header value stored in association with the service from the RAM 104 (step S121). Thereafter, the process proceeds to step S122. In step S121, a withdrawal complete flag indicating a completed state of withdrawal may be stored in association with the service in the RAM 104 without deleting the service determined to be completely withdrawn from the RAM 104.

After the end of step S119, when 30 sec has not elapsed from the transmission of the Subscribe message in step S120, or after the end of step S121, the UPnP control point 150 determines whether or not the service use switching trigger has already been received in step S114 (step S122). If the service use switching trigger has been received, the UPnP control point 150 controls the display unit 105 to display an available service thereon (step S123).

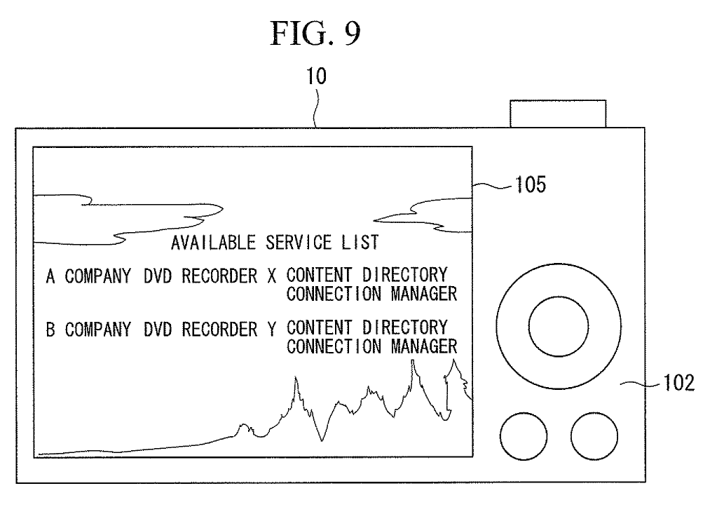

For example, when the available service is displayed, a service list stored in the RAM 104 in step S119 is displayed on the display unit 105 as shown in FIG. 9. Alternatively, only a list of services not associated with the withdrawal complete flag among services stored in the RAM 104 may be displayed. A service list may be displayed by setting a service not associated with the withdrawal complete flag to be active (bright) and setting a service associated with the withdrawal complete flag to be inactive (dark or overlapped with an icon indicating the complete state of withdrawal). Alternatively, the user may be notified of the service withdrawal of only a service associated with a new withdrawal complete flag.

Subsequently, the UPnP control point 150 determines whether or not a Notify message of an event occurrence notification in the service is received (step S124). If the Notify message is received, the process proceeds to step S128.

On the other hand, if the Notify message is not received, the UPnP control point 150 determines whether or not to issue an Action message for performing some control for the UPnP device by an instruction from the user (step S125). If it is not necessary to issue the Action message, the process proceeds to step S128.

On the other hand, if it is necessary to issue the Action message, the UPnP control point 150 transmits the Action message to a service of a use destination (step S126). Subsequently, the UPnP control point 150 determines whether or not a response to the Action message is received (step S127). If the response is not received, the process returns to step S127, the determination is made once again.

If the Notify message is received, if it is not necessary to issue the Action message, or if a response to the Action message is received, the UPnP control point 150 determines whether or not a network join notification (ssdp: alive) is received from the UPnP device (step S128). If the network join notification is not received, the process proceeds to step S114. On the other hand, if the network join notification is received, the UPnP control point 150 determines whether or not the service of the transmission source thereof matches the service stored in the RAM 104 in step S119. Alternatively, the UPnP control point 150 determines whether or not the service of the transmission source matches a service not associated with a withdrawal complete flag among the services stored in the RAM 104 (step S129).

If the service of the transmission source of the network join notification matches a service stored in the RAM 104 or matches a service not associated with the withdrawal complete flag, the process proceeds to step S114. On the other hand, if the service of the transmission source of the network join notification is a service associated with the withdrawal complete flag, not a service stored in the RAM 104, the process proceeds to step S106.

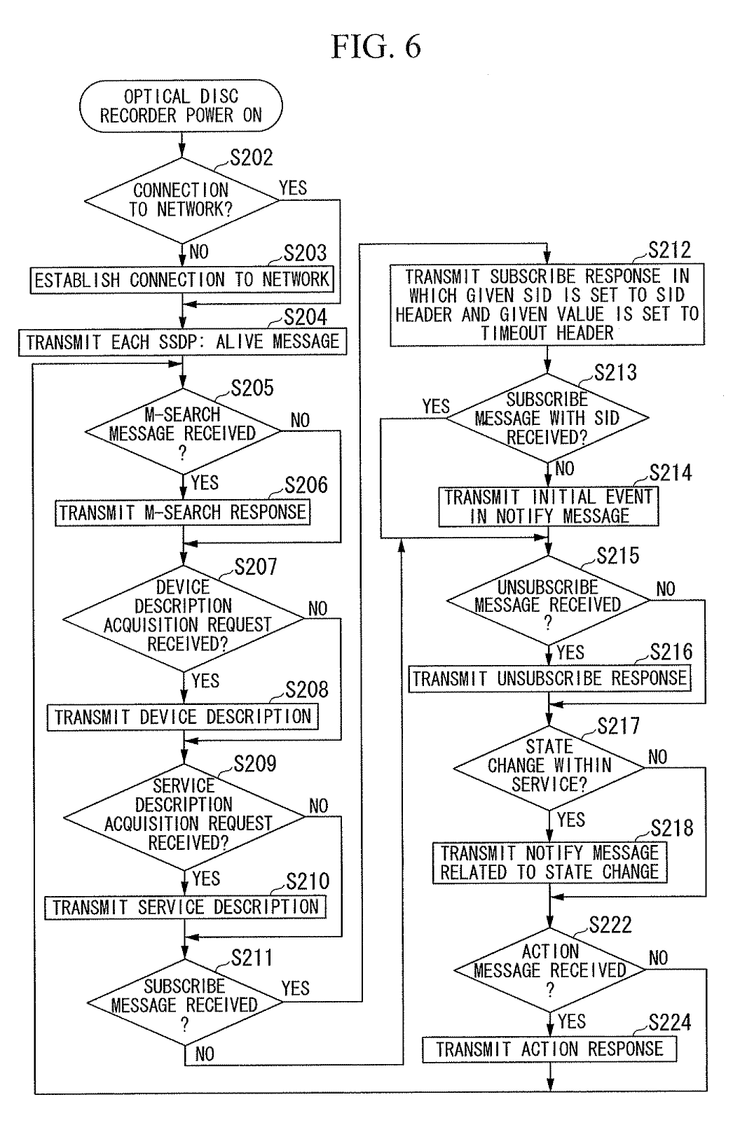

Next, the operation of the optical disc recorder 30 will be described. FIG. 6 shows a procedure for operation of the optical disc recorder 30. Steps S204 to S224 are processing steps of the UPnP device of the related art. When the optical disc recorder 30 is powered on, the UPnP device of the optical disc recorder 30 determines whether or not a connection to the network is established (step S202). If the connection to the network is not established, the UPnP device establishes the connection to the network (step S203). Thereafter, the process proceeds to step S204.

On the other hand, if the connection to the network is established, the UPnP device within the optical disc recorder 30 and a service within each UPnP device transmit a network join notification (ssdp: alive) to the UPnP control point (step S204). Subsequently, the UPnP device determines whether or not an M-SEARCH message is received from the UPnP control point (step S205). If the M-SEARCH message is not received, the process proceeds to step S207. On the other hand, if the M-SEARCH message is received, the UPnP device transmits a response to the M-SEARCH message to the UPnP control point (step S206). Subsequently, the process proceeds to step S207.

When the process proceeds to step S207, the UPnP device determines whether or not a device description acquisition request is received from the UPnP control point (step S207). If the device description acquisition request is not received, the process proceeds to step S209. On the other hand, if the device description acquisition request is received, the UPnP device transmits a device description as a response to the UPnP control point (step S208). Subsequently, the process proceeds to step S209.

When the process proceeds to step S209, the service within the UPnP device determines whether or not a service description acquisition request is received from the UPnP control point (step S209). If the service description acquisition request is not received, the process proceeds to step S211. On the other hand, if the service description acquisition request is received, the service within the UPnP device transmits a service description as a response to the UPnP control point (step S210). Subsequently, the process proceeds to step S211.

When the process proceeds to step S211, the service within the UPnP device determines whether or not a Subscribe message is received from the UPnP control point (step S211). If the Subscribe message is not received, the process proceeds to step S215.

On the other hand, if the Subscribe message is received, the service within the UPnP device sets a given SID in the SID header as a response to the Subscribe message, sets a given value in the TIMEOUT header, and transmits the response to the UPnP control point (step S212). Subsequently, the service within the UPnP device determines whether or not the SID is assigned to the Subscribe message (step S213). A Subscribe message to which the SID is not assigned is a Subscribe message for registering an initial event, and a Subscribe message to which the SID is assigned is a Subscribe message for updating the state of a registered event. If the SID is assigned to the Subscribe message, the process proceeds to step S215. On the other hand, if the service ID is not assigned to the Subscribe message, the service within the UPnP device transmits an initial event for initial state notification as a Notify message to the UPnP control point (step S214). Subsequently, the process proceeds to step S215.

When the process proceeds to step S215, the service within the UPnP device determines whether or not an Unsubscribe (event registration release) message is received from the UPnP control point (step S215). If an Unsubscribe message is not received, the process proceeds to step S217. On the other hand, if an Unsubscribe message is received, the service within the UPnP device transmits a response to the Unsubscribe message to the UPnP control point (step S216). Subsequently, the process proceeds to step S217.

When the process proceeds to step S217, the service within the UPnP device determines the presence/absence of a state change within the service (step S217). If there is no state change within the service, the process proceeds to step S222. On the other hand, if there is a state change within the service, the service within the UPnP device transmits a Notify message for a state change notification to the UPnP control point (step S218). Subsequently, the process proceeds to step S222.

When the process proceeds to step S222, the service within the UPnP device determines whether an Action message is received from the UPnP control point (step S222). If an Action message is not received, the process returns to step S205. On the other hand, if an Action message is received, the service within the UPnP device transmits a response to the Action message to the UPnP control point (step S224). Subsequently, the process returns to step S205.

Next, an example of communication to be performed between the DSC 10, the optical disc recorder 30, and an optical disc recorder 40 will be described. Since the optical disc recorder 40 has the same configuration and function as the optical disc recorder 30, some description of the optical disc recorder 40 is omitted.

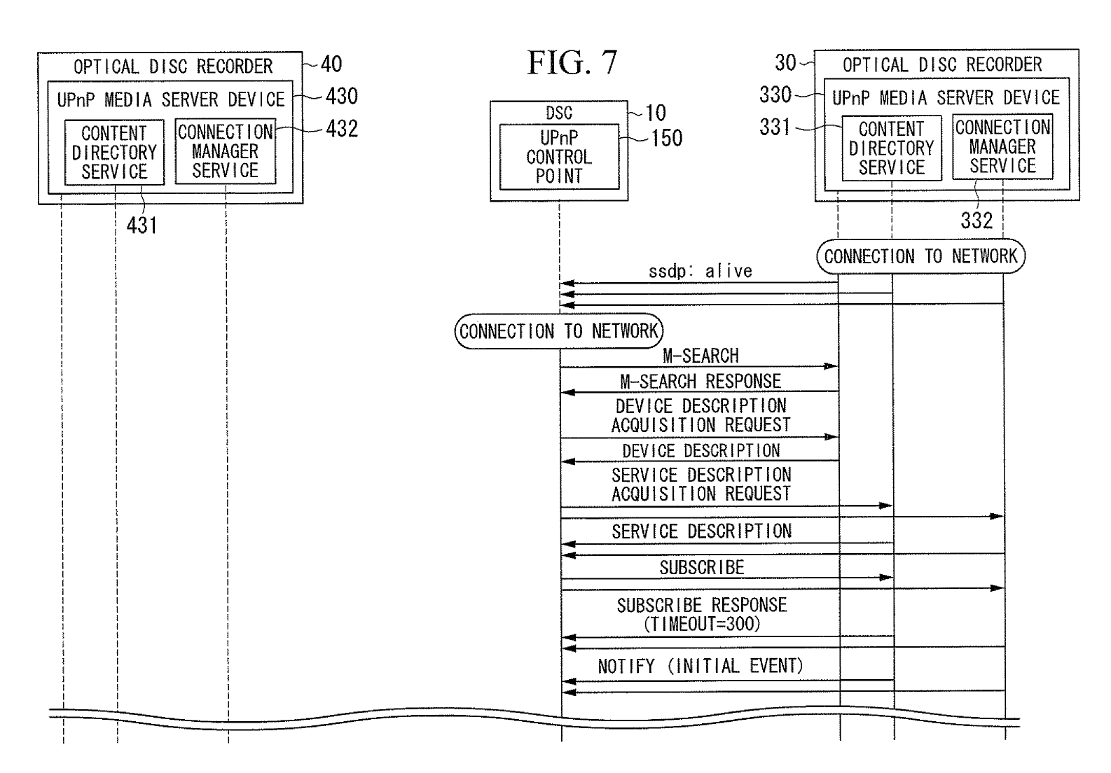

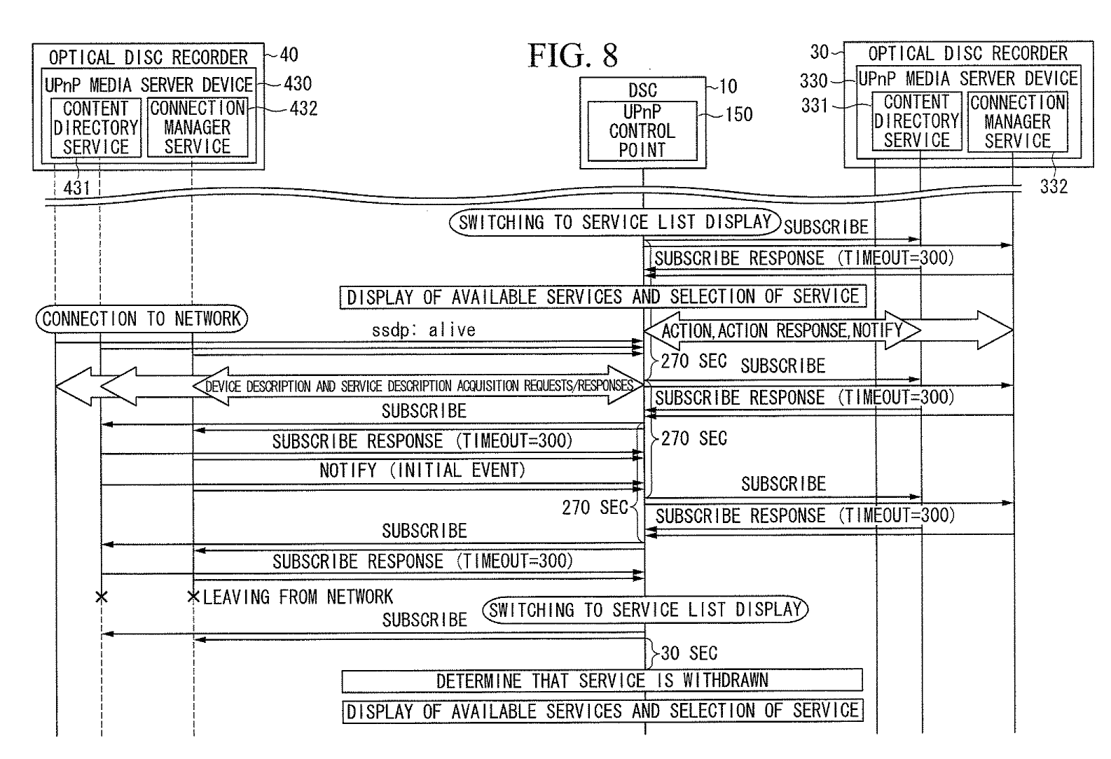

FIGS. 7 and 8 show this communication procedure. The UPnP media server device 330 within the optical disc recorder 30 and services (the content directory service 331 and the connection manager service 332) within the UPnP media server device 330 multicast network join notifications (ssdp: alive) to the network (corresponding to step S204).

On the other hand, when joining the network, the UPnP control point 150 within the DSC 10 multicasts an M-SEARCH message to the network (corresponding to step S103). Upon receipt of the M-SEARCH message, the UPnP media server device 330 transmits an M-SEARCH response as a response to the M-SEARCH message to the UPnP control point 150 (corresponding to steps S205 and S206).

Upon receipt of the M-SEARCH response, the UPnP control point 150 transmits a device description acquisition request to the UPnP media server device 330 based on information described within the M-SEARCH response (corresponding to steps S104 and S106).

Upon receipt of the device description acquisition request, the UPnP media server device 330 transmits a device description related to the UPnP device to the UPnP control point 150 (corresponding to steps S207 and S208).

Upon receipt of the device description from the UPnP media server device 330, the UPnP control point 150 transmits service description acquisition requests to the content directory service 331 and the connection manager service 332 based on information described within the device description (corresponding to steps S107 and S108).

Upon receipt of the service description acquisition requests, the content directory service 331 and the connection manager service 332 transmit service descriptions regarding respective services to the UPnP control point 150 (corresponding to steps S209 and S210).

Upon receipt of the service descriptions from the content directory service 331 and the connection manager service 332, the UPnP control point 150 stores information described within the respective service descriptions (corresponding to steps S109 and S110).

As described above, the UPnP control point 150 receives the device description from the UPnP media server device 330 and receives the service descriptions from the content directory service 331 and the connection manager service 332. Reception acknowledgements correspond to steps S111 and S112.

Subsequently, the UPnP control point 150 transmits Subscribe messages (without the SID) to the content directory service 331 and the connection manager service 332 as the services within the UPnP media server device 330 (corresponding to step S113).

Upon receipt of the Subscribe messages, the content directory service 331 and the connection manager service 332 transmit Subscribe responses in which values (for example, 300) are set in TIMEOUT headers (corresponding to steps S211 and S212).

Upon receipt of the Subscribe responses from the content directory service 331 and the connection manager service 332, the UPnP control point 150 stores the value 300 in association with the services since the value of the TIMEOUT headers is 300 (corresponding to steps S118 and S119).

Since no SID was included in the previously received Subscribe messages, the content directory service 331 and the connection manager service 332 transmit initial events to the UPnP control point 150 by Notify messages (corresponding to steps S213 and S214).

The UPnP control point 150 receives the Notify messages (corresponding to step S124).

When switching the display to the service list display to allow the user to select a service, the UPnP control point 150 transmits Subscribe messages in which the SIDs and TIMEOUT value 300 associated with the services are set for the services, since neither the content directory service 331 nor the connection manager service 332 is in use (corresponding to steps S114 and S115).

Upon receipt of the Subscribe messages, the content directory service 331 and the connection manager service 332 transmit Subscribe responses in which values (for example, 300) are set in the TIMEOUT headers (corresponding to steps S211 and S212).

Since the value of the TIMEOUT headers is 300 when the Subscribe responses are respectively received from the content directory service 331 and the connection manager service 332, the UPnP control point 150 stores the value 300 in association with the respective services (corresponding to steps S118 and S119). Since a service use switching trigger is received by switching the display to the service list display, available services are displayed on the display unit 105 (corresponding to steps S122 and S123). Also, if a service is selected by the user, the selected service is stored as a service in use. Thereafter, in the DSC 10, service usage is started and a screen for each service is displayed on the display unit 105.

Thereafter, an Action message, an Action response, and a Notify message are transmitted and received between the UPnP control point 150, and the content directory service 331 and the connection manager service 332 (corresponding to steps S124 to S127, S217, S218, S222, and S224).

Based on the TIMEOUT value 300 associated with each service, a Subscribe message and a response thereto are transmitted and received between the UPnP control point 150, and the content directory service 331 and the connection manager service 332 at every predetermined time (here, 270 sec) (corresponding to steps S116, S117, S211, S212, S118, and S119).

On the other hand, a UPnP media server device 430 within the optical disc recorder 40 and services (a content directory service 431 and a connection manager service 432) within the UPnP media server device 430 multicast network join notifications (ssdp: alive) to the network (corresponding to step S204).

The UPnP control point 150 receives the network join notifications. At this time, since the content directory service 431 and the connection manager service 432 are not associated by Subscribe responses, the UPnP control point 150 transmits device description acquisition requests for the respective services (corresponding to steps S128, S129, and S106).

Since a device description acquisition request, a service description acquisition request, and responses thereto, a Subscribe message (without SID) and a response thereto, Notify message transmission as an initial event by the Subscribe message (without SID), and the transmission/reception of the Subscribe message at every given time and a response thereto are the same as the above-described operations between the UPnP control point 150, the optical disc recorder 30, description thereof is omitted here.

Here, it is assumed that the content directory service 431 and the connection manager service 432 of the optical disc recorder 40 are unintentionally withdrawn from the network. Thereafter, the UPnP control point 150 switches the display to the service list display to allow the user to select a service. At this time, since the content directory service 331 and the connection manager service 332 of the optical disc recorder 30 are in use, but the content directory service 431 and the connection manager service 432 of the optical disc recorder 40 are not in use, the UPnP control point 150 transmits Subscribe messages in which SIDs and TIMEOUT values of 300 associated with the services are set to the content directory service 431 and the connection manager service 432 (corresponding to steps S114 and S115).

Since the content directory service 431 and the connection manager service 432 are withdrawn from the network, they do not receive the Subscribe messages.

If 30 sec has elapsed in a state in which there has been no response from the content directory service 431 and the connection manager service 432, the UPnP control point 150 determines that the content directory service 431 and the connection manager service 432 has been withdrawn from the network (corresponding to steps S118, S120, and S121). Since a service use switching trigger is received through display switching to the service list display, the UPnP control point 150 displays available services on the display unit 105 (corresponding to steps S122 and S123). Also, if a service is selected by the user, the selected service is stored as a service in use. Thereafter, in the DSC 10, the service use is started and a screen for each service is displayed on the display unit 105.

Next, a modified example of this embodiment will be described. If a service withdrawal message (ssdp: byebye) is received from either service in step S114 of FIG. 5, a Subscribe message may be transmitted to a service not in current use in step S115. For example, if one service transmits a service withdrawal message by detecting a bad ambient radio environment, there is a possibility that other services may also transmit service withdrawal messages by detecting the bad ambient radio environment. However, if the DSC 10 may receive the service withdrawal message from one service, but may not receive the service withdrawal messages from the other services due to the bad radio environment, the DSC 10 may not detect the withdrawal of other services. If the service withdrawal message is received from either service as described above, it is possible to check the validity of a service not in use by transmitting a Subscribe message to the network, so that the service using device can accurately recognize available services.

Instead of displaying available services in step S123 of FIG. 5, a decision may be made to use a scheduled service to be used next. For example, the UPnP control point 150 performs a slide show in which an image group including images within a plurality of services is played. At this time, in a sequence of the slide show, an image of the next play target is set as an image within another service. The service becomes a scheduled service to be used next. Information regarding the sequence of a scheduled service to be used is stored in the RAM 104, and a service to be used next is identified based on the information.

Since it is necessary to switch a service to be used if a play timing when an image within a scheduled service to be used next is reached, the UPnP control point 150 determines that a service use switching trigger is received in step S114. Subsequently, in step S115, the UPnP control point 150 transmits a Subscribe message to the scheduled service to be used next. If a Subscribe response is received from the service, the UPnP control point 150 stores the SID header value and TIMEOUT header value described within the Subscribe response in the RAM 104 in association with the service of the transmission destination of the Subscribe message in step S119.

Subsequently, in step S122, the UPnP control point 150 determines that the service use switching trigger is received in step S114. In step S123, the service is determined to be used if the scheduled service to be used next is stored in the RAM 104 in step S119. Thereby, it is possible to prevent an unintentionally withdrawn service from being erroneously used.

According to this embodiment as described above, the service using device may accurately recognize available services by transmitting a Subscribe message to a service not in use if a service use switching trigger is generated and checking whether or not the service not in use is valid. Even though a network withdrawal message may not be transmitted from the service due to unintended withdrawal, the service using device can rapidly detect the withdrawal of a service without the extension of existing UPnP protocols, or the addition of or change to hardware.

If there is a possibility that a service in current use is switched when the display is switched from another display to the service list display, when the process of ending service use is performed, or when an operation input from the user is received in relation to service switching, the service using device can accurately recognize available services by checking the validity of a service not in use.

When a network withdrawal message is received from either service, the service using device can more accurately recognize available services by transmitting a Subscribe message to a service not in use and checking whether or not the service not in use is valid.

When the service use switching trigger is generated, it is possible to prevent an unintentionally withdrawn service from being erroneously used by at least displaying valid services so as to be distinguishable from invalid services as shown in step S123 of FIG. 5.

That is, according to the present invention, an available service can be accurately recognized by checking whether or not a service not in use is valid when a switching trigger related to service use switching is generated.

While the exemplary embodiments of the invention have been described with reference to the accompanying drawings, the detailed constitutions of the invention are not limited to the foregoing embodiments but embrace changes in design to the extent that they do not depart from the concept of the invention.

What is claimed is:

1. A service using device which operates as a UPnP control point using a service provided by a UPnP device, comprising:
a service registration unit which registers the service;
a storage unit which stores information indicating whether the registered service is in use;
a trigger reception unit which receives a switching trigger related to switching of the service use;
a message transmission unit which transmits an acknowledgement message for checking whether a service stored as a service not in use is valid to a network when the trigger reception unit receives the switching trigger; and
a processing unit which performs processing based on a response to the acknowledgement message.

2. The service using device according to claim 1, further comprising a display unit which displays a registered service,
wherein the trigger reception unit receives the switching trigger when the display unit performs switching from a state in which other information excluding information for selecting the service is displayed to a state in which the information for selecting the service is displayed.

3. The service using device according to claim 1, wherein the trigger reception unit receives the switching trigger when a service use end process is performed for a service in use.

4. The service using device according to claim 1, further comprising a message reception unit which receives a network leave message from the UPnP device,
wherein the trigger reception unit receives a reception trigger when the message reception unit receives the network leave message, and
wherein the message transmission unit transmits the acknowledgement message to the network when the trigger reception unit receives the reception trigger.

5. The service using device according to claim 1, further comprising an operation unit which receives an operation input by a user to the service using device,
wherein the trigger reception unit receives the switching trigger when the operation input is received.

6. The service using device according to claim 1, further comprising a display unit which displays a valid service,
wherein the processing unit causes the display unit to display the valid service to be distinguishable from an invalid service.

7. The service using device according to claim 1,
wherein the storage unit stores information regarding a scheduled service to be used next to a service in current use, and
wherein the processing unit decides whether to use the scheduled service based on a response to the acknowledgement message.
